(19) United States
(12) Patent Application Publication
(10) Pub. No.: US 2015/0140947 A1
(43) Pub. Date: May 21, 2015

(54) Method for placing an emergency call in a vehicle

(71) Applicant: Robert Bosch GmbH, Stuttgart (DE)

(72) Inventors: Alexander MUELLER, Bietigheim (DE); Andreas KORTHAUER, Stuttgart (DE)

(21) Appl. No.: 14/541,453

(22) Filed: Nov. 14, 2014

(30) Foreign Application Priority Data
Nov. 18, 2013 (DE) 10 2013 223 439.2

(51) Int. Cl. H04M 1/725; H04W 4/22

(52) U.S. Cl. CPC H04M 1/72538; H04W 4/22; H04M 1/72541
USPC 455/404.1; 455/556.1

(57) ABSTRACT

A method for placing an emergency call in a vehicle, in which vital data characterizing the condition of the occupant are detected via sensors and the vital data are sent with the emergency call.

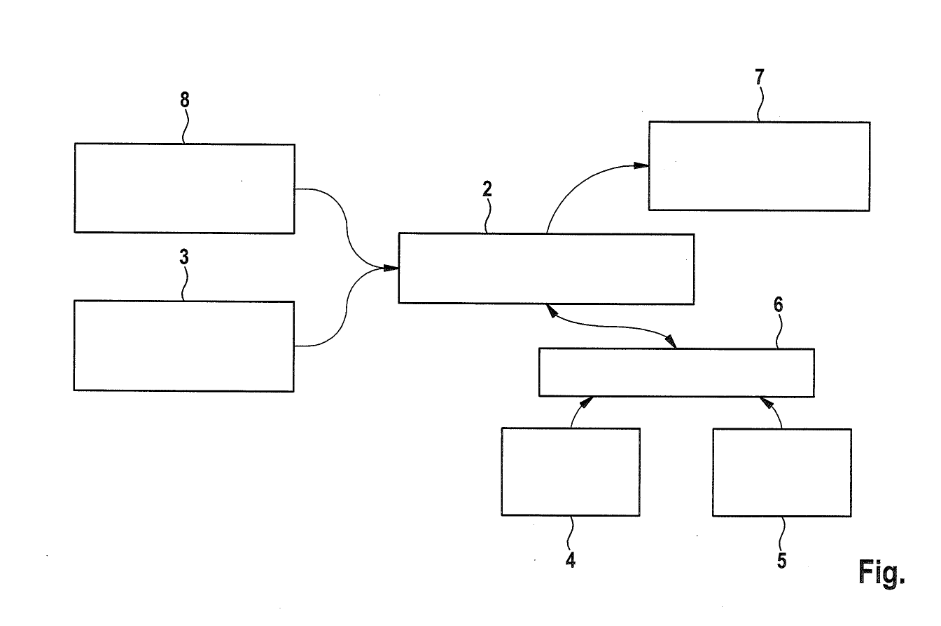

### RELATED APPLICATION INFORMATION

The present application claims priority to and the benefit of German patent application no. 10 2013 223 439.2, which was filed in Germany on Nov. 18, 2013, the disclosure of which is incorporated herein by reference.

### FIELD OF THE INVENTION

The present invention relates to a method for placing an emergency call in a vehicle.

### BACKGROUND INFORMATION

Emergency call systems in motor vehicles are known, which automatically place an emergency call to an emergency call center in the event of a traffic accident, so that assistance measures and rescue measures may be initiated within a short period of time. The emergency call sent to the call center includes, as a dataset, the time of the accident, the coordinates of the place of the accident and, if necessary, the driving direction of the vehicle and characteristics regarding the vehicle. As an alternative to automatically generating the emergency call, it is also possible to transmit the emergency call manually. Moreover, as an option, it is also possible to establish a voice connection between the emergency call center and the vehicle occupants.

### SUMMARY OF THE INVENTION

An object of the present invention is to improve assistance measures for the purpose of caring for vehicle occupants in emergency situations.

This object is achieved according to the present invention with the features described herein. The further descriptions herein specify useful refinements.

The method according to the present invention relates to the placement of an emergency call in a vehicle in the event one or multiple occupants of the vehicle find themselves in an emergency situation. In this case, the condition of the occupant is detected via vital data using sensors, which are sent with the emergency call to an emergency call center. The vital data characterize the instantaneous medical condition of the vehicle occupant, so that corresponding information about the medical condition of the vehicle occupant is available in the emergency call center, and targeted measures based on the vital data may be taken. For example, emergency vehicles equipped with medical devices and resources selected in accordance with the transmitted vital data, and which may be used to specifically treat the vehicle occupants, may be dispatched to the occupants of the vehicle who are in distress.

The vital data are detected via sensors in the vehicle. These include both biometric sensors as well as sensors monitoring the vehicle interior, which supply measured values, from which the instantaneous medical condition of a vehicle occupant may be deduced. Via the biometric sensors, for example, it is possible to ascertain the pulse, skin temperature or a respiration parameter such as, for example, respiration rate or depth of respiration or posture. Such sensors, for example, operate contact-free, for example, via infrared, or measure the electrical resistance of the skin, for example, via electrically conductive gripping areas on the steering area.

Interior sensors in the vehicle for ascertaining vital data include, for example, an optical system, in particular, a camera, via which body movements of the driver deviating from a standard behavior may be detected, for example, a nodding of the head typical of falling asleep or fainting. In addition, sensors for detecting vital data may also be used, via which movements generated by the driver on a unit of the vehicle may be detected, for example, steering angle sensors for ascertaining the steering angle applied by the driver or path sensors or force sensors on the brake or gas pedal. With these sensors, it is possible to ascertain corresponding driving operations, the ascertained measured values indicating an emergency situation if the driver operation exhibits a movement pattern typical of an emergency. In this case, different sensor data may be combined, if necessary, in order to obtain a validation and, therefore, increased reliability when determining an emergency situation. For example, sudden steering movements in conjunction with a visual evaluation of the head movement with the aid of a camera system may provide an indication of whether an emergency situation of the driver in the vehicle actually exists, or whether it is an evasive movement in conjunction with normal steering behavior.

According to one advantageous embodiment, the emergency call may be triggered both manually as well as automatically. The manual triggering occurs via a triggering unit or actuation unit in the vehicle, which must be actuated by a vehicle occupant. Thereafter, the vital data ascertained are transmitted via the emergency call to the emergency call center.

The automatic triggering of the emergency call and the accompanying transmission of the vital data to the emergency call center are automatically triggered when either the vital data themselves and/or at least one parameter characterizing the vehicle condition or the vehicle situation lies outside a normal range. This also includes cases in which no accident has yet occurred, but in which the vital data of a vehicle occupant lying outside the normal range justify the placing of an emergency call.

Also applicable are situations after an accident has already occurred, whereby in these cases the placing of the emergency call may be triggered on the basis of vital data as well as on the basis of parameters characterizing the vehicle condition or the vehicle situation, if each of these lies outside a normal range. The parameters characterizing the vehicle condition are, for example, measured values from acceleration sensors in the vehicle, in particular, for longitudinal and lateral acceleration, or the vehicle speed. Parameters characterizing the vehicle situation may be information from surround sensors of the vehicle, for example, a monitoring of the surroundings with the aid of optical sensors or radar sensors, whereby an accident situation may be deduced on the basis of the measured data which immediately precede the accident.

The automatic triggering of the emergency call on the basis of vital data, which lie outside a normal range, may be carried out before or after the accident has occurred. The manual placement of the emergency call may also be carried out before or after an accident.

During placement of the emergency call, the vital data are, in principle, transmitted together with elementary information, in particular, the coordinates of the instantaneous position of the vehicle and the instantaneous point in time. Furthermore, according to one advantageous embodiment, at least one parameter characterizing the vehicle condition or the vehicle situation is also transmitted with the vital data. Thus, via the emergency call, the emergency call center receives not only the location and point in time of the vehicle or of the placed communication, as well as the vital data, but, in addition, information from the vehicle sensors as well. In the case of an accident, the information from the vehicle sensors, for example acceleration values or speed values, may provide an indication of the severity of the accident, as a result of which corresponding rescue measures may be initiated and better coordinated.

If necessary, a warning to the vehicle occupants in the vehicle is also issued, for example, visually or acoustically, with the placement of an emergency call. A warning may also be issued to other vehicles following or driving alongside; such vehicles optionally include a suitable receiving device for receiving the warning.

The method for placing the emergency call, including transmission of the vital data, is carried out in a device in the vehicle, which includes at least one sensor for detecting vital data of a vehicle occupant, as well as a processing unit for evaluating the sensor data. In addition, the device includes a transmission unit, which is activated by the processing unit and via which the emergency call is sent to the emergency call center.

The device advantageously also includes an actuation unit for manually placing the emergency call. In addition, the device may be assigned at least one sensor, which detects the driving situation or the vehicle situation. The device may also be assigned biometric sensors or sensors for monitoring the vehicle interior or the actuation of a unit in the vehicle by the driver, for example, the pedals.

The condition of the occupant is ascertained in the processing unit on the basis of the received sensor data. If vital data, which represent the condition of the occupant, lie outside a normal range, a corresponding control signal is transmitted to the transmission unit, which sends the vital data via the emergency call to the emergency call center. If necessary, the sending of the emergency call may also be triggered manually via the actuation unit.

Additional advantages and purposeful embodiments may be derived from the additional descriptions herein, the FIGURE description and the drawings.

### BRIEF DESCRIPTION OF THE DRAWINGS

The FIGURE shows a block diagram having the essential features of a device, with which the method for placing an emergency call including vital data may be carried out.

### DETAILED DESCRIPTION

The FIGURE shows a device 1, which is installed in a vehicle and is adapted to place an emergency call including vital data regarding the condition of a vehicle occupant to an emergency call center. Device 1 includes a central processing unit 2, in which data ascertained via sensors are evaluated, and which controls the transmission of the emergency call. Device 1 also includes vehicle sensors 3, at least one biometric sensor 4 and an optical sensor 5 for monitoring the vehicle interior.

The information from biometric sensor 4 and optical sensor 5 may be consolidated in a consolidation unit 6 and processed; consolidation unit 6 may, if necessary, also be directly integrated in processing unit 2, or the functions of consolidation unit 6 may be taken over by processing unit 2.

Device 1 also includes a transmission unit 7, which is activated by signals of processing unit 2, and via which the emergency call is sent to an emergency call center. Finally, device 1 also includes an actuation unit 8, which allows for manual intervention in the transmission of the emergency call.

Via actuation unit 8, it is possible to manually trigger the sending of an emergency call.

Processing unit 2 receives data ascertained sensorily from vehicle sensors 3, biometric sensor 4 and optical sensor 5, and evaluates this information. Vehicle sensors 3 include, for example, speed sensors and acceleration sensors and, if necessary, pressure sensors, via which the pressure in the vehicle body may be ascertained. Vehicle sensors 3 may also include surround sensors, with which the surroundings of the vehicle may be detected, for example, via video sensors or radar sensors.

Block 4 includes at least one biometric sensor, if necessary, multiple biometric sensors, via which the vital data of a vehicle occupant, in particular, of the driver, may be ascertained. Vital data are, for example, pulse, heart rate, respiration, in particular rate of respiration and depth of respiration, as well as skin temperature.

Optical sensor 5 is used to monitor the interior and may also be used to monitor the driver or another vehicle occupant, and to verify the occurrence or existence of an emergency situation. In this case, for example, a sudden head movement may be detected, which exhibits a typical movement path in the event of unconsciousness.

If necessary, block 5 may also include additional sensors, with which the behavior of the driver may be ascertained, for example, a steering angle sensor or a pedal sensor, in order to be able to determine the steering behavior or the pedal actuation by the driver. Even in the case of steering behavior or pedal actuation, there are typical movement patterns, both for normal behavior as well as for unusual behavior, from which an emergency situation may be deduced.

The data from blocks 4 and 5, once they are consolidated and evaluated in consolidation unit 6, are forwarded to processing unit 2, in which all the information is consolidated and interpreted. If the evaluation of processing unit 2 indicates that an emergency situation exists or is potentially immediately imminent, transmission unit 7 may then be automatically activated to place an emergency call. Taken into consideration in such a case are situations before an accident occurs, for example, a sudden deterioration of a vital function of the driver, as well as a driving situation immediately after an accident has occurred, which may also be deduced from the behavior or condition of the driver or from vehicle sensors 3, for example, from an extreme delay or a high pressure on the vehicle body.

In each case, i.e., both before an accident and after an accident has occurred, it is possible to manually generate an emergency call by actuating actuation unit 8.

The emergency call, which is sent via transmission unit 7, includes both the vital data, which are ascertained in the vehicle via the on-board sensors, or ascertained in processing unit 2 from the sensor data, as well as basic information regarding the vehicle, in particular regarding the instantaneous vehicle position and regarding the time and, if necessary, the driving direction. It is also possible to transmit in the emergency call additional information, which characterizes the driving condition or the driving situation, for example, information from vehicle sensors 3.

What is claimed is:

1. A method for placing an emergency call in a vehicle, the method comprising:
detecting, via sensors, vital data characterizing the condition of an occupant; and
sending the vital data with the emergency call.

2. The method of claim 1, wherein the emergency call is triggered manually.

3. The method of claim 1, wherein the emergency call is automatically triggered if the vital data or at least one parameter characterizing the vehicle condition or the vehicle situation lies outside a normal range.

4. The method of claim 3, wherein the emergency call is automatically triggered if from the vital data or the at least one parameter characterizing the vehicle condition or the vehicle situation an accident situation may be deduced.

5. The method of claim 1, wherein the at least one parameter characterizing the vehicle condition or the vehicle situation together with the vital data is sent with the emergency call.

6. The method of claim 1, wherein at least one of a pulse, a skin temperature, respiration and a posture of an occupant are detected as vital data.

7. The method of claim 1, wherein with the placement of the emergency call, a warning is also generated in the vehicle.

8. A device for placing an emergency call in a vehicle, comprising:
a processing unit to evaluate sensor data and to activate a transmission unit, via which the emergency call is placed in the vehicle; and
at least one sensor to detect vital data characterizing a condition of an occupant.

9. The device of claim 8, further comprising:
an actuation unit to manually place an emergency call.

10. The device of claim 8, wherein at least one sensor is for detecting a driving condition or a vehicle situation.

11. The device of claim 8, wherein at least one biometric sensor is for detecting one vital parameter, including at least one of a pulse, a skin temperature, respiration and a posture.

12. The device of claim 8, wherein at least one sensor is for detecting a driver operation, including at least one of a steering behavior or a pedal actuation.
